(19) United States
(12) Patent Application Publication
(10) Pub. No.: US 2025/0256322 A1
(43) Pub. Date: Aug. 14, 2025

(54) METHOD OF MANUFACTURING A SCREW

(71) Applicant: Ludwig Hettich Holding GmbH & Co. KG, Schramberg-Sulgen (DE)

(72) Inventor: Günter STIEBITZ, Waldenburg (DE)

(21) Appl. No.: 19/046,697

(22) Filed: Feb. 6, 2025

(30) Foreign Application Priority Data
Feb. 9, 2024 (DE) 10 2024 103 756.3

(51) Int. Cl. B21H 3/02

(52) U.S. Cl. CPC B21H 3/02

(57) ABSTRACT

A method of manufacturing a screw having a predetermined thread geometry and a screw tip, comprising the steps of: providing a screw blank having a first diameter, the screw blank having a first end corresponding to the leading end of the screw to be manufactured from the screw blank and a second end corresponding to the trailing end of the screw to be manufactured from the screw blank; reducing the first diameter to a second diameter in a first portion adjacent to the first end of the screw blank; processing the blank in said first portion by rolling with flat dies to form a thread in the first portion and said tip as a threaded tip at the first end; and processing the blank in a second portion adjoining the first portion by rolling in an axial continuous process to form a thread in the second portion which continuously continues the thread in the first portion, wherein the first and second diameters of the screw blank are each selected such that during processing in steps C and D a uniform or at least approximately uniform thread having the predetermined thread geometry is formed which extends over the first and second portions.

### FIELD

The present invention relates to a method of manufacturing a screw. In particular, it relates to a method of manufacturing a screw as is advantageous for modern and future-oriented use in structural wood construction.

### BACKGROUND

In order to achieve the global climate targets, it is inevitable to place a strong focus on reducing the CO2 footprint in construction. In this context, the focus is especially on structural wood construction, although at present the proportion of wood construction is still comparatively low in comparison with steel and concrete. Over the past 20 years, there has been a dynamic development worldwide in structural wood construction. The innovations in the fields of wood materials, interconnections and their dimensioning nowadays allow significantly more effective construction structures. For example, 12-story buildings, which years ago seemed so unimaginable, now belong to the state of the art. With its naturally very favorable CO2 footprint, the possible industrial prefabrication and the very short construction times on site, structural wood construction is predestined for sustainable construction and has great development potential in modern construction.

An important prerequisite for this construction method are suitable fasteners, especially screws with a full thread, which can be used to transfer high local load concentrations into the into the wood components. FIGS. 1 a to 1 f schematically illustrate typical applications of such fasteners in structural wood construction, for example reinforcements (FIG. 1 a), transverse tensile reinforcements (FIG. 1 b), main-to-secondary beam connections (FIG. 1 c), reinforcements of beams (FIG. 1 d), reinforcements of notches (FIG. 1 e) and reinforcements of apertures (FIG. 1 f).

It can be seen from the application examples shown in FIGS. 1 a-f that particularly slender and long screws, and in particular fully threaded screws, are required for such applications. In the present disclosure, the term “screw” is to be understood broadly, and also includes a threaded rod. The term “fully threaded screw” is common in the art and refers to screws in which a thread is formed over the majority of their length. For example, a “fully threaded screw” can be a screw with a shank and a thread which extends over at least 75%, preferably at least 80% and particularly preferably at least 90% of the length of the screw shank. However, such long and slender fully threaded screws entail special demands on processability, which in turn makes the manufacture of such fully threaded screws challenging.

A particular challenge is to place the screws exactly according to the dimensioning, and in particular to exactly maintain the distances of the screws from the component edge and the distances between adjacent screws. During assembly, the screws are typically introduced into guide bores, the depth of which is only approximately ten times the nominal diameter d of the screw. In the case of the long and slender screws required for structural wood construction, this means that the screws are screwed in over a multiple of this guide bore length without further pre-drilling, which in practice entails difficulties with the exact placement. According to the findings of the inventor, however, the exact placement can be improved if particular attention is paid to ensuring that the screw is particularly straight during manufacture.

A further requirement is that, in the case of such screws, high loads are transferred between the components to be connected, which places higher demands on strength. Sufficient strengths can be achieved in practice by tempering the screw material, wherein this tempering typically involves a heat treatment.

In the manufacture of such screws, the production of the thread constitutes a central manufacturing step. With regard to cost-saving and material-saving manufacturing, the threads are preferably produced in a rolling process. For screws with moderate thread lengths, rolling with flat dies is appropriate because it permits a very high throughput. In the case of rolling with flat dies, the screw blank is fed between two rolling dies moving against one another and the thread is formed during rolling of the blank. In this method, the forming process takes place primarily in the radial direction, axial deformations occur only to a very small extent. A more detailed description of the rolling process with flat dies can be found, for example, in the textbook Heinz Tatsch, “Praxis der Umformungstechnik”, 7th edition June 2003, wherein the working scheme is illustrated in particular in FIG. 6.1.

However, in the state of the art, threads are rolled only up to a maximum length of 600 mm in the rolling process with flat dies, and no rolling machines are available for larger thread lengths. However, especially for structural wood construction, screws with longer threads are desirable in a number of applications. It is conceivable to extend the rolling process with flat dies to thread lengths of more than 600 mm, but in practice this is difficult because both the machine costs and the tool costs increase disproportionately.

A further difficulty in this regard are the increased demands on strength and the heat treatment generally required thereby: if the screw blank is already heat-treated before rolling, the power requirement in the rolling process also increases in the course of the increase in strength aimed at thereby, according to the findings of the inventor with the same screw geometry, typically by 30 to 50%. This means that in this case the thread lengths of up to 600 mm which can be achieved per se for untreated materials in the flat die process cannot be achieved in practice either. As an alternative to this, the heat treatment can be carried out after rolling of the thread. However, in this case the problem arises that the screw deforms in the course of the heat treatment and has to be straightened in a subsequent step in order to meet the abovementioned demands on straightness.

The power required for rolling depends not only on the length of the thread, but also increases with the diameter of the blank. This means that the rolling lengths of 600 mm available per se in the course of rolling with flat dies are available in practice only for blanks with moderate diameters, but not for blanks with larger diameters, and this even if the blank is not pre-tempered. In any case, limits are placed on the length of threads which can be produced with the rolling process with flat dies.

For the manufacture of screws with larger thread lengths, rolling can be used in the axial through-feed process. In this process, the screw blank is fed between rotating rolling tools. The axes of rotation of the rolling tools are in this case usually inclined with respect to one another such that, during forming of the thread, an axial feed is induced, with which the rolling stock is guided through the process. A detailed description of the axial through-feed process can likewise be found in the textbook Heinz Tatsch, “Praxis der Umformungstechnik”, 7th edition June 2003, in conjunction with FIG. 6.4 shown therein.

### SUMMARY

The invention is based on the object of providing a method which especially permits the manufacture of screws with long threads as are desirable, for example, in structural wood construction. The method according to the invention comprises the steps of:
A. providing a screw blank having a first diameter, the screw blank having a first end corresponding to the leading end of the screw to be manufactured from the screw blank and a second end corresponding to the trailing end of the screw to be manufactured from the screw blank;
B. reducing the first diameter to a second diameter in a first portion adjacent to the first end of the screw blank;
C. processing the blank in said first portion by rolling with flat dies to form a thread in the first portion and a threaded tip at the first end; and
D. processing the blank in a second portion adjoining the first portion by rolling in an axial through-feed process to form a thread in the second portion which continuously continues the thread in the first portion.

The first and second diameters of the screw blank are each selected such that during processing in steps C and D a uniform or at least approximately uniform thread having the predetermined thread geometry is formed which extends over the first and second portions.

The method according to the invention combines two different rolling processes in the manufacture of the screw, namely a step C of rolling with flat dies and a step D of rolling in the axial through-feed process.

By rolling a part of the thread, namely the above-mentioned “second portion”, in the axial through-feed process, screws of practically any length can be produced. This opens up completely new possibilities in structural wood construction, for example using fully threaded screws with a length of more than 1000 mm, especially in a length range of 1300 to 2000 mm, which has not yet been applied in the state of the art. The rolling process in the axial through-feed process also permits the blank to be heat-treated already before rolling in order to increase its strength. As a result, the above-described problems of deformation of the screw in the course of a heat treatment after the thread formation can be avoided, which otherwise would have to be corrected in a complex straightening process in order to meet the abovementioned high demands on the straightness of the screw.

The screw according to the invention has a screw tip in order to permit screwing into a non-pre-drilled part of the anchoring base, for example a wood construction. Following a rolling process in the axial through-feed process, a drilling tip can be formed as a screw tip in a so-called “pinching process” in known manufacturing methods. Such drilling tips are regularly used in wood screws. However, the inventor has found that a substantially better setting behavior can be achieved for the applications aimed at here if a threaded tip is used instead of a drilling tip. In the present disclosure, a “threaded tip” is understood to be a tapering, pointed end portion at the leading end of the screw into which the thread of the screw continues. In particular, a “threaded tip” can be a tapering end portion which has a thread turn over at least 50%, preferably at least 70% of its axial length. The inventor has found that the exact setting of the screw according to the dimensioning can be achieved significantly better in the applications described above if a threaded tip is present instead of a drilling tip.

According to the findings of the inventor, the threaded tip is in practice substantially better suited to guiding the screw on its comparatively long path through the non-pre-drilled anchoring base and to setting it exactly at the planned position usually predetermined by the dimensioning. This applies in particular if comparatively large thread pitches are used which in turn are advantageous for the efficient setting of long fully threaded screws. Suitable thread pitches p for nominal thread diameters up to 10 mm are for example between 60% and 90%, preferably between 65% and 90%, and particularly preferably between 70% and 80% of the nominal diameter, and for nominal diameters above 10 mm (irrespective of the exact diameter) for example between 6.5 and 9.0 mm, preferably between 7.0 and 8.0 mm. With such thread pitches, the drilling tip does not offer the desired centering effect which is desirable for large thread lengths.

In order to provide such a threaded tip, the first portion of the screw blank is formed in step C in a rolling process with flat dies together with a first portion of the overall thread. Here, the invention makes use of the fact that such threaded tips can be formed particularly well in the rolling process with flat dies.

This thread is then “extended” in step D in said rolling process in the axial through-feed process. Specifically, the blank is processed in the second portion adjoining the first portion by rolling in an axial through-feed process to form a thread in the second portion which continuously continues the thread in the first portion. However, it should be noted here that the rolling process in the axial through-feed process, unlike the rolling process with flat dies, is associated with a significant axial deformation of the rolling stock, which inter alia depends on the deformation strength of the rolling stock. In order to compensate for this axial deformation, it is provided in step B to reduce the first diameter of the blank from step A in the subsequent step B in said first portion, in which the thread (and the threaded tip) is to be formed by a rolling process with flat dies, beforehand to a second diameter.

Specifically, the first and second diameters of the screw blank are each selected such that during processing in steps C and D a uniform or at least approximately uniform thread having the predetermined thread geometry is formed which extends over the first and second portions. In this way, screws can be produced efficiently with very long threads which at the same time can be set very exactly. In some embodiments, the second diameter can for example be reduced by 3.5% to 20% compared to the first diameter to obtain a uniform thread after processing in steps C and D.

In an advantageous embodiment, the screw blank provided in step A comprises or consists of a tempered material, in particular tempered steel. In this case, the tempered material is in particular a heat-treated material. The two rolling processes from steps C and D can also be carried out without problems on a tempered material with increased strength. In this way, a subsequent heat treatment with the described problem of deformation can be avoided. In principle, practically all high-strength corrosion-resistant materials can be used which, despite their strength, can advantageously be processed in the combined rolling process according to the invention.

In preferred embodiments, the step of tempering, in particular heat-treating the screw blank or a precursor product of the screw blank before step A can be part of the method.

In preferred embodiments, the length of the thread extending over the first and the second portion is at least 500 mm, preferably at least 650 mm, particularly preferably at least 1000 mm and very particularly preferably at least 1500 mm.

The aforementioned term “thread geometry” is to be understood broadly. In particular, the thread geometry can be characterized by a nominal diameter d and the thread pitch p. In other words, for example, a combination of nominal diameter d and thread pitch p already defines a thread geometry within the meaning of the present disclosure. In addition, the thread geometry can also be characterized by a core diameter. In the art, the “nominal diameter” d usually refers to the outer diameter of the thread of the screw.

In preferred embodiments, said first portion has a length L1 corresponding to at least six thread turns, i.e. a length L1≥6·p. However, in this case, L1≥9·p is preferred. The length of the first portion should be long enough that the thread formed therein can subsequently be precisely continued by the tool for rolling in the axial through-feed process.

In preferred embodiments, said first portion has a length of at most 150 mm, preferably at most 120 mm, particularly preferably at most 100 mm and in particular at most 80 mm. These lengths permit an efficient reduction of the diameter of the blank in the first portion (step B).

As mentioned at the outset, the first and second diameters are matched to one another such that, despite the different rolling processes in steps C and D, a uniform or at least approximately uniform thread having the predetermined thread geometry is formed which extends over the first and second portions. An “at least approximately uniform thread having the predetermined thread geometry” can in particular be a thread in which the outer diameter in the uniform or at least approximately uniform thread extending over the first and second portions varies by less than +/−10.0%, preferably less than +/−5.0%, particularly preferably less than +/−3.5% and very particularly preferably less than +/−2.5%.

Preferably, the following applies to the product of the k-th power of the nominal diameter d in millimeters and the length L_{G} in millimeters of the uniform thread extending over the first and second portions:

$${L}_{G} \cdot {d}^{k} \leq 10 , 000$$

wherein k=1.3. In the above relationship, the numerical values of the length L_{G} and of the nominal diameter d in each case in millimeters are to be used without dimensions. As mentioned at the outset, the method according to the invention is particularly suitable for the manufacture of very long screws. However, it also offers advantages in the case of smaller thread lengths which could in principle be produced over the entire length by rolling with flat dies, both with regard to the energy consumption and the wear of the tools. According to a preferred embodiment, the method is thus also carried out for screws whose product of thread length L_{G} and nominal diameter d at the power of 1.3 falls below the above limit. In this case, these are thread lengths which in principle can still be produced by rolling with flat dies but lie in a range in which the advantages of the method according to the invention can nevertheless be exploited.

In an advantageous development, a screw head is formed at the second end of the screw blank. Herein, the screw head can be formed by cold forming, in particular by upsetting and pressing. In alternative embodiments, however, the screw head can also be formed by hot forming, wherein the workpiece is preferably heated inductively.

Preferably, steps B and C are carried out in a continuous process on the same machine or in the same machine line.

In an advantageous embodiment, the thread is a wood screw thread. Preferably, the wood screw thread is a self-tapping thread for wood connections which permits screwing of the screw into wood without pre-drilling. Such threads are known per se in the art and are not assigned to a direct standard, but are usually checked via a manufacturer's approval and released for use in wood construction. Screws with such self-tapping wood screw threads are also referred to in the art as “chip board screws”, which, however, are common in substantially shorter lengths than in the preferred embodiments provided here.

Preferably, the screw is a fully threaded screw.

In an advantageous embodiment, the thread is a concrete thread or a facade construction thread.

In an advantageous embodiment, ribs are rolled in at the thread base in step C and/or step D.

In an advantageous development, teeth are formed at least in portions at least in the thread in the first portion.

### BRIEF DESCRIPTION OF THE DRAWINGS

Further advantages and features of the invention will become apparent from the following description, in which the invention is explained in more detail with reference to an exemplary embodiment. In the figures:

FIGS. 1 a-f show typical illustrative applications for long fully threaded screws in structural wood construction;

FIG. 2 shows an intermediate product of a screw in a manufacturing method according to an embodiment of the invention after step B;

FIG. 3 shows an intermediate product of the screw of FIG. 2 in the manufacturing method according to an embodiment of the invention after step C;

FIG. 4 shows the finished screw which is obtained in the manufacturing method according to an embodiment of the invention after step D.

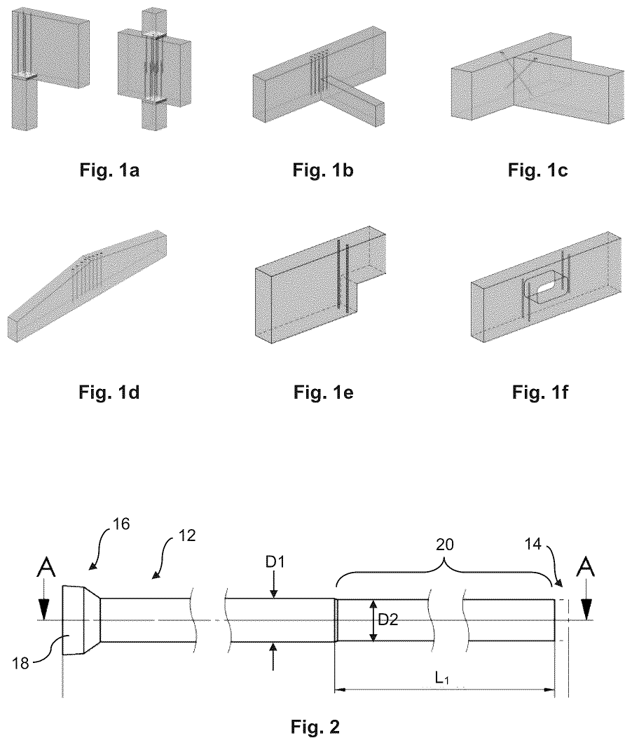

### DETAILED DESCRIPTION

FIGS. 2 to 4 show intermediate products or the end product of a full-thread wood screw 10 (see FIG. 4) which is produced according to the method of the invention.

In a method step A, a screw blank 12 having a first diameter D1 is provided. The screw blank has a first end 14 corresponding to the leading end of the screw 10 to be manufactured from the screw blank and a second end 16 corresponding to the trailing end of the screw to be manufactured from the screw blank 12. In the embodiment shown, a screw head 18 is already formed at the second end 16. Furthermore, the blank 12 is already tempered by heat treatment and therefore has an increased strength.

In a second method step B, the diameter is reduced from the first diameter D1 to a second diameter D2 in a first portion 20 adjacent to the first end 14 of the screw blank. The blank 12 thus obtained is shown in FIG. 2. In the exemplary embodiment shown, the first portion 20 has a length L1 of 100 mm.

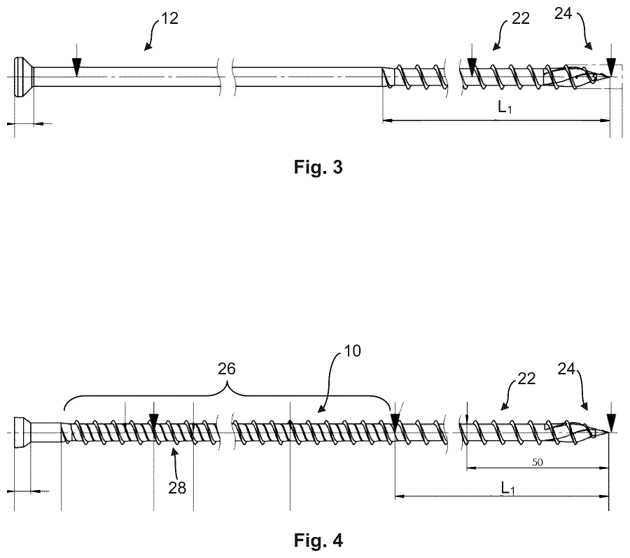

In a subsequent method step C, the blank 12 is processed in the first portion 20 by rolling with flat dies to form a thread 22 (see FIG. 3) in the first portion 20 and a threaded tip 24 at the first end 14. The intermediate product after method step C is shown in FIG. 3.

In a subsequent method step D, the blank 12 is processed in a second portion 26 adjoining the first portion 20 by rolling in an axial through-feed process to form a thread 28 in the second portion 26 which continuously continues the thread 22 in the first portion 20. In the exemplary embodiment shown, the second portion is 1100 mm long, so that a thread length of 1200 mm results overall. With the method described here, such full-thread screw lengths can be produced without problems.

In the case of rolling the second portion 26 in the axial through-feed process, the blank 12 (unlike in the case of the rolling process with flat dies) is significantly deformed in the axial direction. This axial deformation, together with the larger initial diameter D1, leads to the thread geometry in the second portion 26 matching that in the first portion 20. The reduction of the diameter in method step B is accordingly dimensioned precisely such that after step D, as shown in FIG. 4, a uniform (or at least approximately uniform) thread having the predetermined thread geometry results which extends over the first and second portions 20, 26. In the specific context, “uniform thread geometry” means that the threads in the first and second portions 20, 26 match (or at least approximately match) both with regard to their pitch p and with regard to their nominal diameter.

### REFERENCE NUMERAL LIST

10 fully threaded screw
12 blank
14 first end
16 second end
18 screw head
20 first portion
22 thread in the first portion
24 threaded tip
26 second portion
28 thread in the second portion

What is claimed is:

1. A method of manufacturing a screw having a predetermined thread geometry and a screw tip, comprising the steps of:
A. providing a screw blank having a first diameter, the screw blank having a first end corresponding to the leading end of the screw (10) to be manufactured from the screw blank and a second end corresponding to the trailing end of the screw to be manufactured from the screw blank;
B. reducing the first diameter to a second diameter in a first portion adjacent to the first end of the screw blank;
C. processing the blank in said first portion by rolling with flat dies to form a thread in the first portion and said tip as a threaded tip at the first end;
D. processing the blank in a second portion adjoining the first portion by rolling in an axial through-feed process to form a thread in the second portion which continuously continues the thread in the first portion;
wherein the first and second diameters of the screw blank are each selected such that during processing in steps C and D a uniform or at least approximately uniform thread having the predetermined thread geometry is formed which extends over the first and second portions.

2. The method according to claim 1, wherein the screw blank provided in step A comprises or consists of a strengthened steel.

3. The method according to claim 1, wherein the screw blank provided in step A comprises or consists of a strengthened material, wherein the strengthened material is a heat-treated material.

4. The method according to claim 1, further comprising a step of strengthening the screw blank or a precursor product of the screw blank before step A.

5. The method according to claim 1, wherein the length of the thread extending over the first and the second portion is at least 500 mm.

6. The method according to claim 1, wherein the thread geometry is characterized by a nominal diameter d and a thread pitch p.

7. The method according to claim 6, wherein the thread geometry is additionally characterized by a core diameter.

8. The method according to claim 1, wherein said first portion has a length corresponding to at least six thread turns.

9. The method according to claim 1, wherein said first portion has a length of at most 150 mm.

10. The method according to claim 1, wherein the outer diameter in the uniform or at least approximately uniform thread extending over the first and second portions varies by less than +/−10.0%.

11. The method according to claim 1, wherein the outer diameter in the uniform or at least approximately uniform thread extending over the first and second portions varies by less than +/−5.0%.

12. The method according to claim 1, wherein the following applies to the product of the k-th power of the nominal diameter d in millimeters and the length L_{G} in millimeters of the uniform thread extending over the first and second portions:
$${L}_{G} \cdot {d}^{k} \leq 10 , 000$$
wherein k=1.3.

13. The method according to claim 1, wherein a screw head is further formed at the second end of the screw blank.

14. The method according to claim 13, wherein the screw head is formed by cold forming or by hot forming.

15. The method according to claim 1, wherein steps B and C are carried out in a continuous process on the same machine or in the same machine line.

16. The method according to claim 1, wherein the thread is a wood screw thread.

17. The method according to claim 1, wherein the screw is a fully threaded screw.

18. The method according to claim 1, wherein the thread is a concrete thread or a facade construction thread.

19. The method according to claim 1, wherein, in one or both of steps C and step D, ribs are rolled in at the thread base.

20. The method according to claim 1, wherein teeth are formed at least in portions at least in the thread in the first portion.
